(19) United States
(12) Patent Application Publication
(10) Pub. No.: US 2004/0125870 A1
(43) Pub. Date: Jul. 1, 2004

(54) Interconnecting device with built-in power line communication modem

(76) Inventor: Kenichi Yamazaki, Yokohama-shi (JP)

Correspondence Address: Jonathan P. Osha, ROSENTHAL & OSHA L.L.P., 1221 McKinney St., Suite 2800, Houston, TX, 77010, US

(21) Appl. No.: 10/394,102

(22) Filed: Mar. 21, 2003

(30) Foreign Application Priority Data
Dec. 17, 2002 (WO) PCT/JP02/13167

(51) Int. Cl. H04B 1/38

(52) U.S. Cl. 375/222

(57) ABSTRACT

An interconnecting device with a built-in power line communication modem comprises a modem section 51 for power line communication and an interconnecting section 52 having a function of a switching hub. The connection of a computer to the interconnecting section 52 enables power line communication by the modem section 51, and the connection of a terminal and a peripheral to the interconnecting section 52 enables network configuration. A plurality of power receptacles 4 are further provided so that power can be supplied to devices connected to the interconnecting section 52.

### BACKGROUND OF THE INVENTION

1. Field of the Invention

The present invention relates to a communication device utilizing a power line as a signal transmission medium, and more particularly, to a device suitable for use in configuring a computer network via the power line, which achieves easiness enhancement, space saving, and so on of network configuration.

2. Description of the Related Art

In recent years, with the widespread use, development, and the like of the Internet, proposals and development have been made of a communication system utilizing a power line as a signal transmission medium for connecting so-called client terminals and so on to the Internet or as a signal transmission medium in configuring a computer network such as LAN (Local Area Network), and at the same time, various kinds of power line communication modems have been proposed (refer to, for example, Japanese Patent Laid-open No. 2001-94483 and so on) for connecting client terminals and so on to power lines to establish communication.

Such a power line communication modem has conventionally been so structured that it is provided only with a function for power line communication. Therefore, when, for example, LAN is to be configured utilizing the power line communication, it is necessary to separately connect a so-called interconnecting device such as a hub to this modem. This necessitates not only installation spaces for the respective devices and an additional wiring between the modem and the interconnecting device, but also wiring connection of the modem and the interconnecting device to a commercial power supply respectively. Accordingly, installation work takes a lot of trouble, and in addition, a disadvantage of complicatedness is caused since the plural wirings are arranged around the devices.

### SUMMARY OF THE INVENTION

The present invention is made in light of the above circumstances, and its object is to provide an interconnecting device with a built-in power line communication modem which is provided with a function as an interconnecting device in a computer network in addition to a function as a power line communication modem and which enables reduction in installation space compared with a prior art.

It is another object of the present invention to provide an interconnecting device with a built-in power line communication modem which requires as short a time as possible for an installation work and a wiring work.

It is still another object of the present invention to provide an interconnecting device with a built-in power line communication modem with high easiness and convenience of network configuration.

According to a first aspect of the present invention, provided is an interconnecting device with a built-in power line communication modem, comprising: a modem section for power line communication enabling a terminal having a client function to be connected to the Internet via a power line; and an interconnecting section, to which the terminal and a peripheral are connected, for interconnecting input/output signals to/from these terminal and peripheral, the modem section and the interconnecting section being accommodated integrally in the interconnecting device with the built-in power line communication modem.

Unlike a conventional structure, such a structure not only enables the Internet communication via a power line without separately providing a power line communication modem and an interconnecting device, but also can facilitate network configuration via the power line.

According to a second aspect of the present invention, provided is a power line network system, comprising: a terminal communicatable with the Internet; an interconnecting device with a built-in power line communication modem which comprises a modem section for power line communication communicatably connecting the terminal to the Internet via a power line, and an interconnecting section, to which the terminal and a peripheral are connected, for interconnecting input/output signals to/from these terminal and peripheral, the modem section and the interconnecting section being accommodated integrally in the interconnecting device with the built-in power line communication modem; and a communication network including the power line and the Internet network.

### BRIEF DESCRIPTION OF THE DRAWINGS

FIG. 1 is a block diagram of an interconnecting device with a built-in power line communication modem according to an embodiment of the present invention;

FIG. 2 is a block diagram showing a configuration example of a modem section used in the interconnecting device with the built-in power line communication modem shown in FIG. 1;

FIG. 3 is a block diagram showing a configuration example of an interconnecting section used in the interconnecting device with the built-in power line communication modem shown in FIG. 1;

FIG. 4(A) and FIG. 4(B) are entire perspective views each showing an example of the outer appearance of the interconnecting device with the built-in power line communication modem according to the embodiment of the present invention, FIG. 4(A) being an entire perspective view when the entire device is seen from a front side thereof, and FIG. 4(B) being an entire perspective view when the entire device is seen from a rear side thereof;

FIG. 5 is a schematic view schematically showing a system configuration example using the interconnecting device with the built-in power line communication modem according to the embodiment of the present invention; and

FIG. 6 is a subroutine flowchart showing a basic processing procedure in remote control using the interconnecting device with the built-in power line communication modem according to the embodiment of the present invention.

### DETAILED DESCRIPTION OF THE PREFERRED EMBODIMENTS

Hereinafter, the present invention will be explained in detail with reference to the attached drawings.

It is to be understood that the members, arrangement, and so on explained below are not to limit the present invention, and various changes and modifications can be made within the sprit and scope of the present invention.

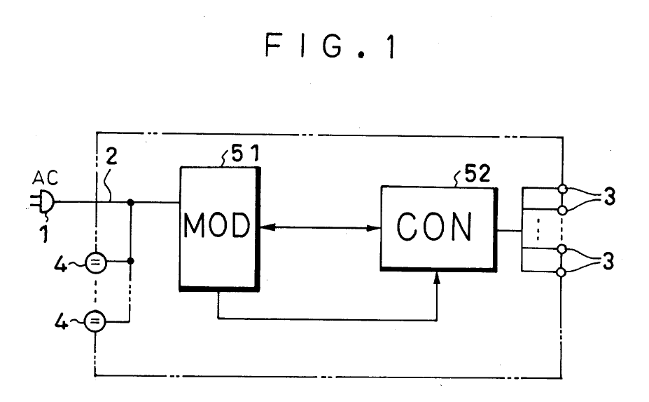

First, a basic configuration example of an interconnecting device with a built-in power line communication modem according to an embodiment of the present invention will be explained with reference to FIG. 1.

The interconnecting device with the built-in power line communication modem according to the embodiment of the present invention is mainly composed of a modem section (denoted by ‘MOD’ in FIG. 1) 51 and an interconnecting section (denoted by ‘CON’ in FIG. 1) 52.

The modem section 51 in the embodiment of the present invention has a function as a modem which performs signal processing for input/output signals necessary for power line communication and a function of rectifying and supplying to the interconnecting section 52 a commercial alternating power supply applied thereto via a power plug 1 and a power cord 2 (to be detailed later).

The interconnecting section 52 carries out functions of performing processing and so on necessary for outputting signals, which are inputted thereto via the modem section 51, to client terminals and so on connected to a plurality of ports 3 and for inputting to the modem section 51 signals from the client terminals and so on connected to the plural ports 3. In the embodiment of the present invention, the interconnecting section 52 has a function as a so-called switching hub, and in addition, it has a function of the connection with terminals such as the client terminals having a so-called computer function and peripherals such as printers, a function of wireless LAN connection, and so on (to be detailed later).

Further, in the interconnecting device with the built-in power line communication modem according to the embodiment of the present invention, the power cord 2 is branched with one or a plurality of power receptacle(s) 4 being connected thereto so that devices provided in the periphery of this interconnecting device with the built-in power line communication modem can secure power supply for operation through the use of the power receptacles 4.

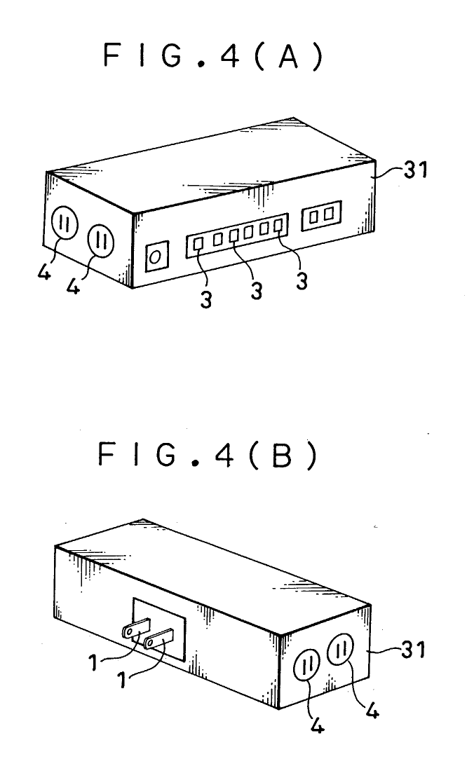

FIG. 4(A) and FIG. 4(B) show an example of an outer structure of the interconnecting device with the built-in power line communication modem having such a structure, and this outer structure example will be explained below with reference to these drawings.

The interconnecting device with the built-in power line communication modem according to the embodiment of the present invention is so structured that it has a case 31, for example, in a rectangular pallalepiped shape as shown in FIG. 4(A) and FIG. 4(B), and the aforesaid modem section 51, interconnecting section 52, and so on are accommodated therein.

The plural ports 3 are provided on an appropriate face of the case 31 so that a not-shown terminal and peripheral can be connected thereto (refer to FIG. 4(A)). Note that, here, the ‘terminal’ means a terminal having a function as a computer and serving as a client terminal, irrespective of the form of the structure such as portable, desktop, and so on, and the ‘peripheral’ means a peripheral connected to the terminal, for example, a printer, an external memory, and the like, which operates by receiving operation control from the terminal.

The power plug 1 is fixed on a face opposite the face on which the plural ports 3 are provided (refer to FIG. 4(B)) so that, when the power plug 1 is put into a not-shown power receptacle, the whole case 31 is placed at a position of the power receptacle, being supported by the power plug 1.

In addition, the one or plural power receptacle(s) 4 is(are) provided on another appropriate face of the case 31 so that, when a power plug of a not-shown device is put therein, a commercial alternating power supply can be supplied to this device.

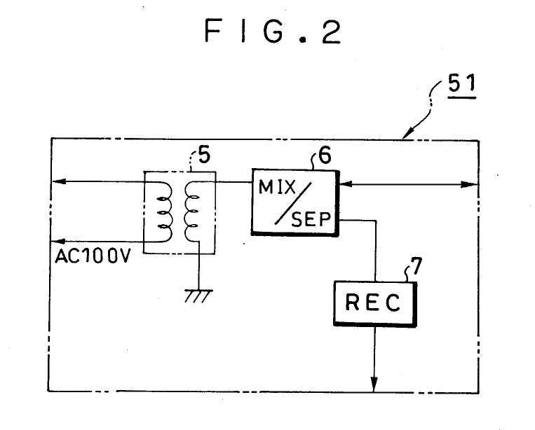

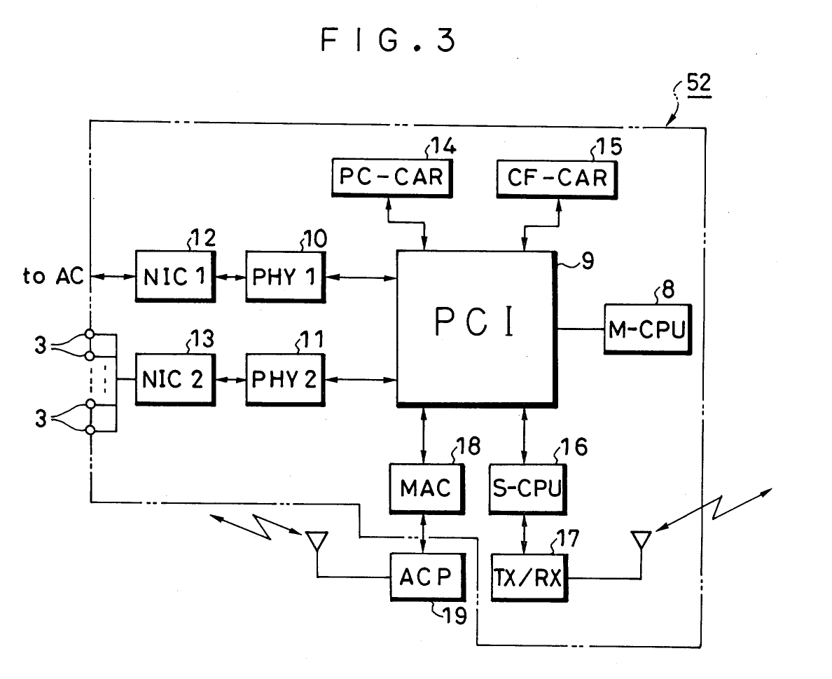

Next, more concrete configuration examples of the modem section 51 and the interconnecting section 52 will be explained with reference to FIG. 2 and FIG. 3.

To explain the configuration example of the modem section 51 first with reference to FIG. 2, the modem section 51 includes a transformer 5, a mixer/separator (denoted by ‘MIX/SEP’ in FIG. 2) 6, and a rectifying circuit (denoted by ‘REC’ in FIG. 2) 7.

The transformer 5 is intended for insulating a not-shown indoor power wiring to which this interconnecting device with the built-in power line communication modem is connected, from an outdoor power wiring, and the power plug 1 (refer to FIG. 1) is to be connected to a primary side thereof. A secondary side of the transformer 5 is connected to the mixer/separator 6.

The mixer/separator 6 has a generally known structure which constitutes an essential part of a modem for power line communication. Specifically, the mixer/separator 6 has a function of separating a signal, which is inputted thereto via the transformer after transmitting a not-shown power line, from the commercial alternating power supply to output the signal to the interconnecting section 52, and of outputting the commercial alternating power supply to the rectifying circuit 7, while having a function of superimposing a signal outputted from the interconnecting section 52 on the commercial alternating power supply.

The rectifying circuit 7 outputs the commercial alternating power supply outputted from the mixer/separator 6 after smoothing the commercial alternating power supply and removing a noise and so on therefrom, and the commercial alternating power supply outputted from this rectifying circuit 7 is applied to the interconnecting section 52 as an operation power supply.

Next, a configuration example of the interconnecting section 52 will be explained with reference to FIG. 3.

The interconnecting section 52 is so structured that it has a main data processing part (denoted by ‘M-CPU’ in FIG. 3) 8 for performing total operation control, data processing, and so on, and the plural ports 3 and so on are connected to this main data processing part 8 via a PCI (Peripheral Component Interconnect) bridge 9 as will be described next. Here, a microcomputer or the like having a generally known structure is a concrete example suitable for use as the main data processing part 8.

The PCI bridge (denoted by ‘PCI’ in FIG. 3) 9 is a generally known bus bridge based on a generally known bus architecture which is designed and managed by PCI SIG (Peripheral Component Interconnect Special Interest Group).

A first physical device (denoted by ‘PHY 1’ in FIG. 3) 10 is first connected to this PCI bridge 9. Then, a first NIC (Network Interface Card) 12 is connected to this first physical device 10.

The first physical device 10 is a physical layer LSI (Large Scale Integration) having a generally known structure, which has a function of a physical layer in a so-called OSI reference model.

The first NIC (denoted by ‘NIC 1’ in FIG. 3) 12 is an interface card having a generally known structure, and in the embodiment of the present invention, it is connected to the aforesaid mixer/separator 6 so that it carries out an interface function for signals transmitted/received between the mixer/separator 6 and this interconnecting section 52.

Further, a second physical device (denoted by ‘PHY 2’ in FIG. 3) 11 is connected to the PCI bridge 9, and a second NIC (Network Interface Card) 13 is further connected to this second physical device 11, to which, as will be described later, connected are the plural ports 3 allowing terminals such as a personal computer and a peripheral such as a printer to be connected thereto. The standard conforming to, for example, a 10BASE-T system or a 100BASE-TX system is suitable for the standard of the plural ports 3.

Incidentally, the second physical device 11 and the second NIC (denoted by ‘NIC 2’ in FIG. 3) 13 basically have the same structure and function as those of the first physical device 10 and the first NIC 12 respectively.

A PC card slot part (denoted by ‘PC-CAR’ in FIG. 3) 14 and a CF card slot part (denoted by ‘CF-CAR’ in FIG. 3) 15 are further connected to the PCI bridge 9 respectively.

The PC card slot part 14 has a slot (not shown) for accommodating a not-shown PC card conforming to the PCMCIA (Personal Computer Memory Card International Association) standard so that peripherals of a so-called personal computer can be connected thereto through the use of the PC card.

Meanwhile, the CF card slot part 15 is intended for accommodating an interface card of a so-called CF card which has, similarly to the PC card, a function of connecting a network device thereto, and when the interface card is put therein, various kinds of peripherals can be connected.

Further, the structure as described below enables a client terminal and so on, and a so-called LAN to be connected to the PCI bridge 9 by a Bluetooth system.

Specifically, first, in order to realize the connection of the client terminal and so on by the Bluetooth system, a sub data processing part (denoted by ‘S-CPU’ in FIG. 3) 16 is connected to the PCI bridge 9, and a transmitting/receiving part (denoted by ‘TX-RX’ in FIG. 3) 17 is further connected to this sub data processing part 16 so that a Bluetooth interface function is realized.

First, the sub data processing part 16 has a generally known structure in which processing of signals transmitted/received via the transmitting/receiving part 17, operation control for signal transmission/reception based on the Bluetooth system, and so on are performed, and a concrete example thereof suitable for use is a microcomputer or the like having a generally known structure.

The transmitting/receiving part 17 has a generally known structure in which signals are transmitted and received to/from not-shown portable terminals and so on by the Bluetooth system.

Next, in order to realize the connection of the wireless LAN, a medium access control part (denoted by ‘MAC’ in FIG. 3) 18 is connected to the PCI bridge 9. This medium access control part 18 is a generally known one intended for realizing a function of a medium access control sub-layer which is a lower sub-layer of a data link layer of an OSI reference model, and it performs processing necessary for signal transmission/receipt to/from a wireless access point 19 described next.

The wireless access point (denoted by ‘ACP’ in FIG. 3) 19 is preferably connected to this medium access control part 18 outside the interconnecting device with the built-in power line communication modem. The wireless access point 19 is a wireless interconnecting device conforming to the specifications of IEEE (Institute of Electrical and Electronics Engineers) 802.11a, IEEE 802.11b, or the like. Therefore, when a not-shown client terminal has a wireless communication function with this wireless access point 19, power line communication is enabled via this interconnecting device with the built-in power line communication modem.

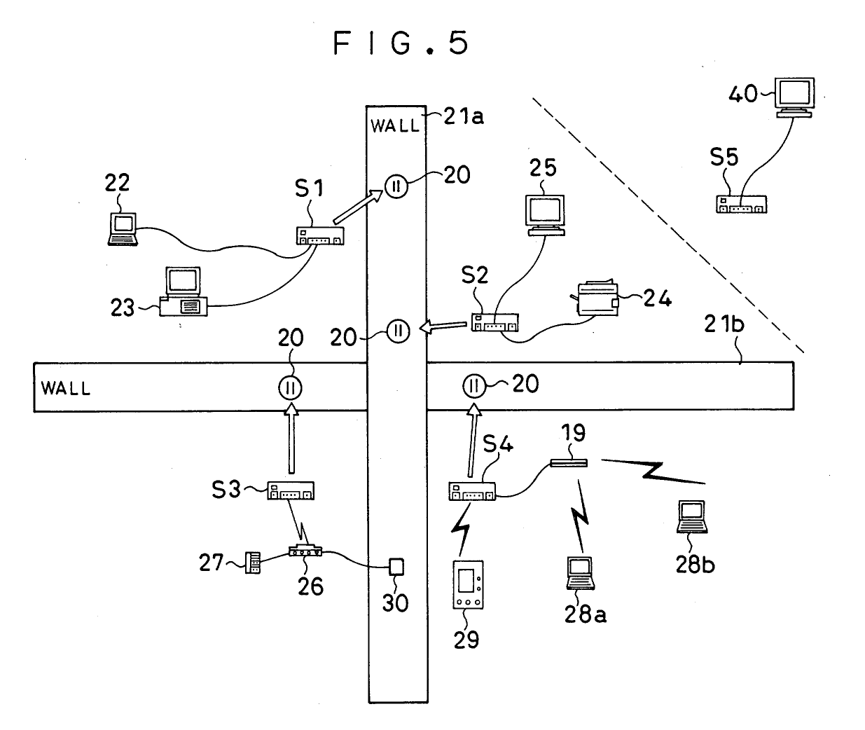

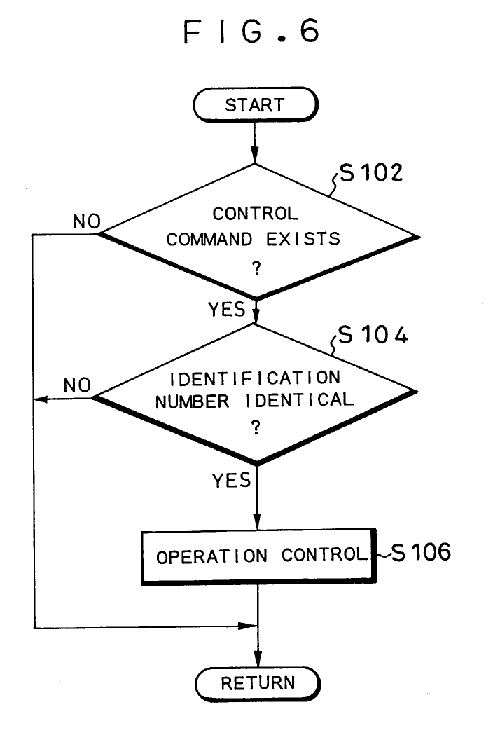

Next, a usage example and operation of the interconnecting device with the built-in power line communication modem as structured above will be explained with reference to FIG. 5 and FIG. 6.

First, the usage example of the interconnecting device with the built-in power line communication modem according to the embodiment of the present invention will be explained with reference to FIG. 5. Incidentally, different reference symbols S1 to S5 are assigned to the interconnecting devices with the built-in power line communication modems in FIG. 5 respectively for the convenience of the explanation, but all of them have the same structure as that explained with reference to FIG. 3.

First, as a matter of course, each of the interconnecting devices with the built-in power line communication modems S1 to S5 is also so structured that a power plug thereof (not shown) is put into any one of power receptacles in its periphery, namely, power receptacles 20 which are usually provided, for example, in walls 21a, 21b, and so on of a house so that it is supplied with a commercial alternating power supply and transmits/receives signals of the power line communication. Incidentally, in FIG. 5, the outline arrows indicate that the not-shown power plugs of these interconnecting devices with the built-in power line communication modems S1 to S4 are put into the power receptacles 20 respectively.

In FIG. 5, a portable personal computer 22 and a so-called desktop personal computer 23 which is, for example, IBM compatible are connected to the plural ports 3 of the interconnecting device with the built-in power line communication modem S1.

Meanwhile, a printer 24 and a computer system are connected to the plural ports 3 of the interconnecting device with the built-in power line communication modem S2, the computer system being generally called a work station 25 and being provided with a plurality of functions such as communication in addition to functions of administrative processing, graphics drawing, and so on.

Further, a modem 26 for, for example, ADSL (Asymmetric Digital Subscriber Line) communication utilizing a telephone line is connected to the port 3 of the interconnecting device with the built-in power line communication modem S3. A telephone 27 is connected to this modem 26, and a not-shown connection terminal for telephone line of the modem 26 is connected to a connection receptacle 30 for telephone line provided in the wall 21a.

In addition, as explained previously with reference to FIG. 3, the wireless access point 19 is connected to the interconnecting device with the built-in power line communication modem S4. Then, portable personal computers 28a, 28b having a communication function with this wireless access point 19 are provided.

A PDA (Personal Digital Assistant) 29 can be further connected to the interconnecting device with the built-in power line communication modem S4 by the Bluetooth system.

In such a configuration, various kinds of the devices such as the portable personal computer 22 connected to the interconnecting devices with the built-in power line communication modems S1 to S4 form a network with one another via not-shown power lines or the Internet network as not-shown communication networks.

Specifically, for example, when a document is to be outputted to the printer 24 using the portable personal computer 22, a control signal for the printer 24 outputted from the portable personal computer 22 is inputted to the second NIC 13 of the interconnecting device with the built-in power line communication modem S1, and inputted to the main data processing part 8 via the second physical device 11 and the PCI bridge 9 after necessary signal conversion and so on are performed.

Then, a document output command is newly outputted to the printer 24 from the main data processing part 8, and the command is outputted to a not-shown indoor power line from the power plug 1 via the PCI bridge 9, the first physical device 10, and the first NIC 12.

In the interconnecting device with the built-in power line communication modem S2 to which the printer 24 is connected, when the aforesaid document output command is inputted to the main data processing part 8 via the first NIC 12, the first physical device 10, and the PCI bridge 9, it is judged in the main data processing part 8 that this command is for the printer 24, based on a preset ID or the like for device identification which is appended to this command.

Then, the document output command for the printer 24 is outputted from this main data processing part 8 of this interconnecting device with the built-in power line communication modem S2 via the PCI bridge 9, the second physical device 11, and the second NIC 13 so that document output is executed in the printer 24.

Detailed explanation of the operations between the other devices, which are basically the same, will be omitted here. To briefly state other typical usage forms utilizing the power line network besides the use of the aforesaid printer 24, first, for example, the portable personal computers 28a, 28b can use the aforesaid printer 24 via the wireless access point 19 and can access the Internet network through ADSL using the modem 26. Note that other computers such as the desktop personal computer 23 can similarly use the printer 24 and utilize ADSL through the use of the modem 26.

Further, the PDA 29 is connected to the interconnecting device with the built-in power line communication modem S4 by the Bluetooth system so that it can use the aforesaid printer 24 and can access the Internet network through ADSL.

Moreover, all of the portable personal computer 22, the desktop personal computer 23, the work station 25, and the portable personal computers 28a, 28b are of course capable of communicating with the Internet network via a provider utilizing the power line communication.

Next, remote operation control of each of the devices using the interconnecting devices with the built-in power line communication modems S1 to S4 in the embodiment of the present invention will be explained.

First, in the embodiment of the present invention, the main data processing part 8 of any of the interconnecting devices with the built-in power line communication modems S1 to S4 is provided with a generally known SNMP (Simple Network Management Protocol) agent. Devices whose operations are to be controlled by this SNMP agent among various kinds of the devices connected to the interconnecting devices with the built-in power line communication modems S1 to S4 are assigned in advance identification numbers for device discrimination. The data is stored in advance in the main data processing parts 8 of the interconnecting devices with the built-in power line communication modems S1 to S4 to which the object devices are connected.

Meanwhile, assuming that the network using the interconnecting devices with the built-in power line communication modems S1 to S4 shown in FIG. 5 is configured in the same building, a computer provided with an SNMP manager 40 is provided, for example, in an external part, namely, in a different building. Of course, in this case, it is a precondition, needless to say, that this computer 40 can perform power line communication via the interconnecting device with the built-in power line communication modem S5 having the structure shown in the embodiment of the present invention.

Under such a precondition, a basic processing procedure commonly executed in the interconnecting devices with the built-in power line communication modems S1 to S4 which are provided with the SNMP agents will be explained with reference to FIG. 6, the processing procedure being executed in response to the receipt of commands from the computer provided with the SNMP manager 40.

To begin with, the processing shown in FIG. 6 is processing which is repeatedly executed at a predetermined cycle as subroutine processing in the main data processing parts 8 of the interconnecting devices with the built-in power line communication modems S1 to S4. When the processing is started, it is first judged whether or not the input of the control command from the computer provided with the SNMP manager 40 exists (refer to Step S102 in FIG. 6). Here, the control command means a command for controlling the operations of the devices such as the printer 24 connected to the interconnecting devices with the built-in power line communication modems S1 to S4.

Then, when it is judged in Step S102 that no input of the control command exists (NO), a series of the processing is finished, while, when it is judged that the input of the control command exists (YES), it is judged whether or not an identification number of the device to be an object of the control command is identical to that of a device connected thereto (refer to Step S104 in FIG. 6). For example, in the main data processing part 8 of the interconnecting device with the built-in power line communication modem S2, identification numbers assigned in advance to the work station 25 and the printer 24 respectively are stored, and it is judged whether or not the stored data and the identification number in the control command are identical to each other.

Then, when it is judged in Step S104 that the device number is not identical (NO), a series of the processing is finished while, when it is judged that the device number is identical (YES), the operation control is performed according to the inputted control command for the device assigned this identification number (refer to Step S106 in FIG. 6).

As is described hitherto, according to the present invention, a power line communication modem and an interconnecting device for computer network are integrated so that wiring work is greatly reduced and work efficiency in installation can be improved compared with those in a conventional art. Moreover, unlike the conventional art, it is not necessary to purchase the power line communication modem and the interconnecting device for computer network separately so that introduction cost can be reduced.

Further, the power line communication modem and the interconnecting device for computer network are integrated so that network configuration utilizing the power line communication is facilitated compared with the conventional art.

In addition, since the power receptacles for commercial power supply are provided, power can be easily supplied to various devices connected to this interconnecting device with the built-in power line communication modem, and unlike the conventional art, it is not necessary to lay a power supply wiring to a power receptacle in its periphery for each of the devices so that a messy state of the periphery of the devices due to many power supply wirings and so on can be prevented.

What is claimed is:

1. An interconnecting device with a built-in power line communication modem, comprising:
a modem section for power line communication enabling a terminal having a client function to be connected to the Internet via a power line; and
an interconnecting section, to which said terminal and a peripheral are connected, for interconnecting input/output signals to/from these terminal and peripheral,
wherein said modem section and said interconnecting section are accommodated integrally in said interconnecting device with the built-in power line communication modem.

2. An interconnecting device with a built-in power line communication modem according to claim 1,
wherein said modem section includes a mixer/separator superimposing a signal for power line communication on a commercial alternating power supply and separating a signal for the power line communication from the commercial alternating power supply, and
wherein said interconnecting section is connected to the mixer/separator so as to enable the signals for the power line communication to be inputted and outputted to/from the terminal and the peripheral connected to this interconnecting section via said mixer/separator.

3. An interconnecting device with a built-in power line communication modem according to claim 2,
wherein said interconnecting section has a Bluetooth interface function which enables connection to the terminal or the peripheral by a Bluetooth system.

4. An interconnecting device with a built-in power line communication modem according to claim 3,
wherein said interconnecting section allows the terminal and the peripheral to be connected thereto via a wireless access point.

5. An interconnecting device with a built-in power line communication modem according to claim 4,
wherein said interconnecting section is provided with an SNMP agent to enable an external terminal provided with an SNMP manager to control, via the power line, operations of the terminal and the peripheral connected to this interconnecting section.

6. An interconnecting device with a built-in power line communication modem according to claim 5,
wherein said modem section has a transformer and a rectifying circuit, a primary side and a secondary side of said transformer being connected to the power line and the mixer/separator respectively,
wherein said mixer/separator is structured to output the signal separated from the commercial alternating power supply to said interconnecting section and output the commercial alternating power supply, and
wherein said commercial alternating power supply outputted from said mixer/separator is applied to said rectifying circuit, and a rectified output of this rectifying circuit is supplied to said interconnecting section as a power supply thereof.

7. An interconnecting device with a built-in power line communication modem according to claim 6,
wherein a power receptacle is provided in the primary side of the transformer, this power receptacle being integrated with a case.

8. An interconnecting device with a built-in power line communication modem according to claim 7,
wherein a power plug is provided being integrated with the case to be insertable directly into an external power receptacle.

9. A power line network system, comprising:
a terminal communicatable with the Internet;
an interconnecting device with a built-in power line communication modem which comprises a modem section for power line communication communicatably connecting said terminal to the Internet via a power line, and an interconnecting section, to which said terminal and a peripheral are connected, for interconnecting input/output signals to/from these terminal and peripheral, the modem section and the interconnecting section being integrally accommodated in said interconnecting device with the built-in power line communication modem; and
a communication network including said power line and the Internet network.

10. A power line network system according to claim 9,
wherein the interconnecting section of said interconnecting device with the built-in power line communication modem is capable of controlling operations of the terminal and the peripheral connected to this interconnecting section based on a control command inputted from an external terminal via the power line.

11. A power line network system according to claim 10,
wherein the interconnecting section is provided with an SNMP agent while the external terminal transmitting the control command via the power line is provided with an SNMP manager.

12. A power line network system according to claim 11,
wherein the terminal and the peripheral connected to the interconnecting section are assigned identification numbers respectively, and the terminal provided with the SNMP manager selects a device to be an object of the operation control based on said identification number.
